(19) United States
(12) Patent Application Publication
(10) Pub. No.: US 2004/0257993 A1
(43) Pub. Date: Dec. 23, 2004

(54) Method and device for network reconfiguration

(76) Inventors: Olav Lysne, Bekkestua (NO); Jose Duato, La Eliana (ES); Timothy Pinkston, Santa Monica, CA (US)

Correspondence Address: BIRCH STEWART KOLASCH & BIRCH, PO BOX 747, FALLS CHURCH, VA, 22040-0747, US

(21) Appl. No.: 10/809,376

(22) Filed: Mar. 26, 2004

Related U.S. Application Data
(60) Provisional application No. 60/457,308, filed on Mar. 26, 2003.

(30) Foreign Application Priority Data
Mar. 26, 2003 (NO) 2003 1374

(51) Int. Cl. H04L 1/00

(52) U.S. Cl. 370/230; 370/235

(57) ABSTRACT

The present invention describes a method and system that allows a network to alter its routing strategy from one routing function to another while the network is up and running. For networks with link level backpressure, the method provides a deadlock free transition between the routing strategies. A variant of the method also guarantees that all packets will be delivered in order.

### FIELD OF THE INVENTION

The present invention relates to computer networks, and more specifically to a deadlock free method and a system for altering a network routing from a first routing function to a second routing function during the operation of the network.

### BACKGROUND OF THE INVENTION

Certain network technologies make use of link level flow control. This basically means that the sending side in a network element can only send data if the receiving side in the network element has buffer capacity to receive it. The property of link level flow control guarantees that no data packet will be dropped inside the network, thus all sent data packets will eventually arrive at its destination. The present invention is particularly useful for networks using link level flow control.

For networks with link level backpressure, the inventive method provides a deadlock free transition between the routing strategies. A variant of the method also guarantees that all packets will be delivered in order.

The said class of networks has historically been used as processor and disk inter-connects in large supercomputers, as well as in computer clusters. Examples of technologies that have this property include current and emerging network technologies such as InfiniBand/PCIExpress, Myrinet, Autonet and Servernet/Tnet.

Furthermore, features for link level flow control have been included in recent Ethernet specifications.

One basic disadvantage of these prior art technologies is that they are prone to deadlocks. We say that a network has deadlocked if there is a set of packets in the network such that all of these packets must wait for another packet in the set to proceed before it can proceed itself.

The problem of network deadlocks itself is well known, and can easily be documented as a subject of research for the last 15-20 years. Freedom from deadlocks in a network is handled through carefully choosing the right routing function. Handling deadlocks in the transition from one routing function to another is, however, very complex.

Basically, there are three prior art approaches for deadlock free network reconfiguration.

The first approach is to stop the network completely during reconfiguration. This is a common method used in the industry today.

The second approach is known as partial progressive reconfiguration, ref. R. Casado, F. J. Quiles, J. L. Sánches, and J. Duato, “Deadlock free routing in irregular networks with dynamic reconfiguration”, in proceedings of CANPC'99, pages 165-180, Springer-Verlag, 1999. This method is confined to one particular routing scheme called Up/Down. It is complex, and does not guarantee in-order delivery of packets.

The third approach is known as The Double Scheme, ref. R. Pang, T. Pinkston, and J. Duato, “The double scheme: Deadlock-free dynamic reconfiguration of cut-through networks”, in proceedings of 2000 International Conference on Parallel Processing (29th ICPP'00), Toronto, Canada, August 2000, Ohio State Univ. This method is rather simple, but it requires a lot of functionality in the switches that very few technologies provide.

### SUMMARY OF THE INVENTION

An object of the present invention is to provide a method that allows a network to alter its routing strategy from a first routing function R_{old} to a second routing function R_{new} while the network is up and running without creating deadlocks in the transition phase. A network will typically comprise several different networks elements, e.g. switches, with input and output ports connected to each other as well as traffic nodes, e.g. servers, terminals etc.

The result of the inventive method is that data packets are sent either according to R_{old} or R_{new}, i.e. no data packets are routed according to R_{old}, in one network element and R_{new} in another. The method provides that for each link between input ports and output ports, data packets are sent solely according to R_{old} before the links starts sending data packets solely according to R_{new}.

One implementation of the method for deadlock free altering of a network routing from a first routing function R_{old}, defining an established connection between a plurality of communication input ports I₁, . . . ,Iₙ and output ports O₁, . . . ,Oₘ, in a network element, to a second routing function R_{new}, defining an new connection between the said input and output ports, for execution by the network element for transmitting and receiving data packets comprises:

(1) for each input port Iᵢ, performing the following steps:

(1a) applying the first routing function R_{old} for the input port,

(1b) receiving a token on an input port Iᵢ,

(1c) applying the second routing function R_{new} for the input port Iᵢ,

(1d) forwarding data packets to every output port Oⱼ associated with the input port Iᵢ according to the second routing function R_{new}, provided that the output port Oⱼ has transmitted the token,

(2) for each output port Oⱼ, performing the following steps:

(2a) determining if the token has been received on all input ports associated with the output port Oⱼ according to the first routing function R_{old},

(2b) transmitting the token on the output port Oⱼ when the token has been received on all said input ports.

The method is further described by the dependent claims 2 to 8.

The steps described above are not necessarily performed as a sequence, but may be performed in another order than the one listed.

The invention further comprises a computer program and computer network system with a number of network elements applying the inventive method as put forth in the claims.

An object of the invention is to provide a method which guarantees in-order delivery of data packets, and a method that is easy to implement.

Still another object of the invention is to provide such a method that works on any network topology, and between any pair of first and second routing functions.

A further object of the invention is to provide such a method that involves improved fault tolerance. As clusters, big servers and supercomputers grow large, the mean time between failures in any given component decreases. Therefore the ability to handle faulty components in the interconnect network is of growing industrial importance. The invention should therefore allow the handling of faulty components in the network through transition into a second routing function that does not use the faulty component at all.

A further object of the invention is to provide such a method that involves hot plug-ability. This means that components can be added to the network and taken into use while the network is up and running. For a network this means a transition from one routing function to another that uses more components than what was previously available.

A further object of the invention is to provide such a method that involves load adaptation. Different routing functions have different properties for different traffic load. Networks therefore come into situations where they can benefit from altering their routing functions in order to optimize performance under a given load.

A further object of the invention is to provide such a method for use with network elements, e.g. switches, which implement link-level flow control.

Still another object of the invention is to provide a network element for performing such a method, a computer network comprising such network elements, and a computer program which performs such a method when the program is executed by a processing device in a network element.

The above objects are completely or partially achieved by a method as set forth in the appended independent claims.

Further objects and advantages are achieved by the features set forth in the dependent claims.

### BRIEF DESCRIPTION OF THE DRAWINGS

The invention will now be described in further detail by way of examples, and with reference to the accompanying drawings, where:

FIG. 1 is a schematic block diagram illustrating a network element (e.g. switch) with external interpreting unit performing the inventive method.

FIG. 2 is a schematic block diagram illustrating a network element (e.g. switch) with internal interpreting unit performing the inventive method.

FIG. 3 is a schematic block diagram showing token received on input ports 1 and 3.

FIG. 4 is a schematic block diagram showing that token arrives on input port 2.

FIG. 5 is a schematic block diagram showing the consequence of the step in FIG. 4.

FIG. 6 is a flowchart illustrating the method according to the invention.

### DETAILED DESCRIPTION OF THE INVENTION

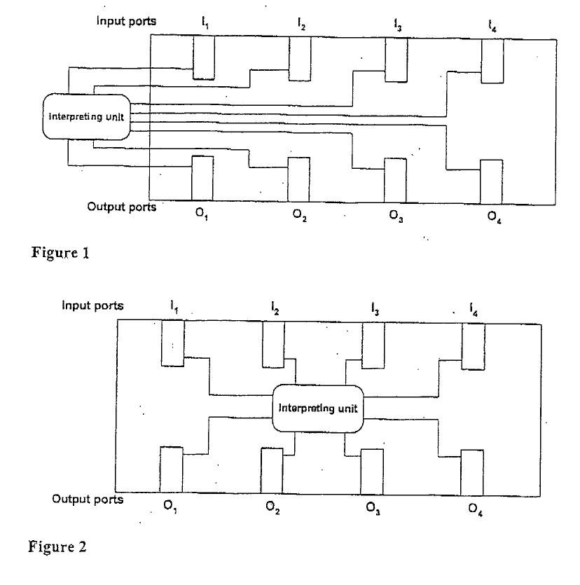

FIG. 1 shows an example of an external interpreting unit. The interpreting unit is the unit where the method according to the invention is performed. This unit will typically comprise elements such as CPU, memory, buffer, routing tables etc. that are necessary for implementing the method according to the invention.

FIG. 2 show a preferred implementation of the invention, where the interpreting unit performing the method according to the invention is incorporated in the input/output element itself, e.g. switch.

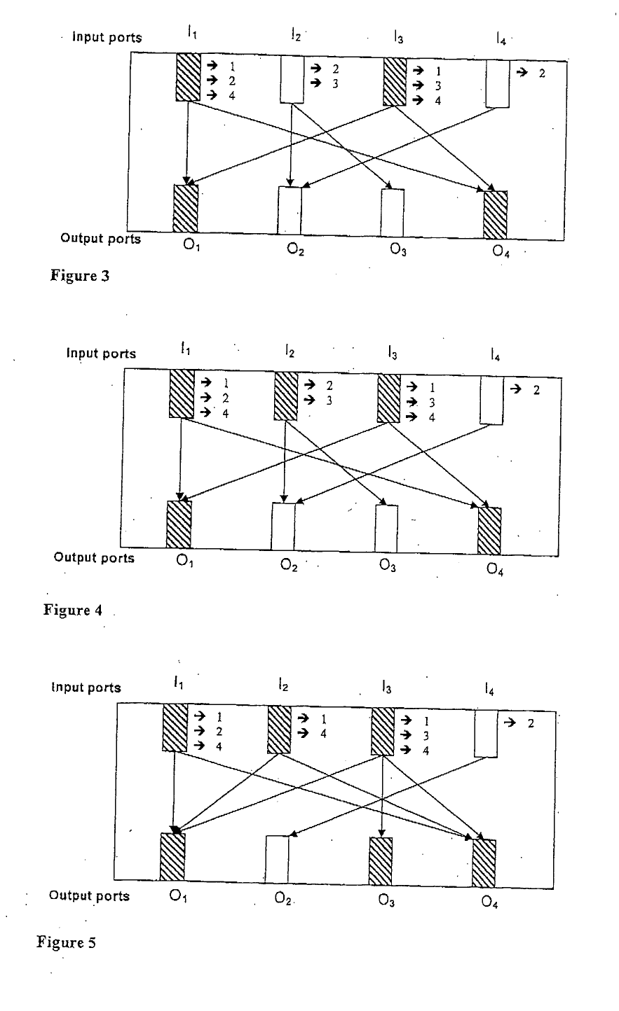

FIGS. 3 to 5 shows the dynamics of the method according to the invention. Each figure illustrates respectively the state of a switch during reconfiguration at three different points in time. Each figure shows a switch with four input ports and four output ports. Each port is depicted with a smaller standing rectangle. The figures are schematic. Most technologies will have several input and output ports constituting a physical bidirectional link. In the figures the input and output ports have been depicted separately for clarity.

Input ports that are shaded imply that the token has been received by the input port. Output ports that are shaded imply that the token has been transmitted by the output port.

To the right of each input port it is indicated which output port this input port transmits packets to, according to the routing function that is currently active for this port. For ports that have received the token this will be the new routing function, and for ports that have not received the token this will be the old routing function.

The arrows from input to output ports show which input port is currently allowed to forward packets to which output port. Input ports that have received the token should only forward packets to output ports that have transmitted the token. Input ports that have not received the token should only forward packets to output ports that have not transmitted the token. This ensures that as long as there are input ports that have not received the token that may forward data to a given output port, the token is not transmitted on this output port.

FIG. 3 illustrates a situation where the token has been received on input ports 1 and 3, and it has been transmitted on output ports 1 and 4. Even if input port 1 is supposed to forward packets to output port 2, and input port 3 is supposed to forward packets to output port 3 according to the new routing function that these input ports have started using, they are not allowed to do so. The reason is that output ports 2 and 3 have not transmitted the token themselves, because they can still expect packets that has been routed according to the old routing function from input ports 2 and 4.

FIG. 4 illustrates that the token arrives on input port 2, thus this port is now shaded.

FIG. 5 illustrates what must happen in the switch as a consequence of the situation in FIG. 4. Output port 3 must now transmit the token, since it can no longer expect any packets from an input port that has not received the token. The restriction that input port 3 can not forward packets to output port 3 is lifted, since output port 3 has now transmitted the token. The restriction that input port 1 can not forward packets to output port 2 is maintained, because output port 2 can still expect packets from input port 4 routed according to the old routing function. Finally input port number 2 must start using the new routing table for all further packets. This is illustrated in the figure where the table to the right of the port is changed.

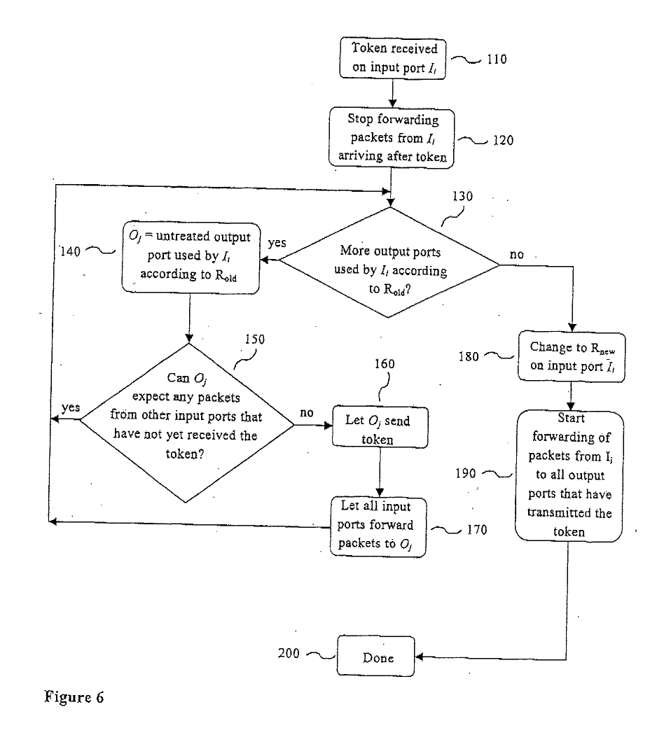

FIG. 6 is a flowchart illustrating one implementation of the method according to the invention. The flowchart shows the steps to be performed to achieve deadlock free altering of network routing according to the invention. More particularly, the flowchart shows the procedure performed when one particular input port Iᵢ in a network element, e.g. switch, receives a token. This procedure will be performed either synchronous or sequential on all the input ports in the network elements.

In the flowchart rectangle 110 denotes that a token has been received on an input port. Previous to this, the input port is using a routing function denoted as R_{old}. When receiving a token, the input port will stop forwarding data packets arriving after the token, as denoted by 120. Following this, a test is performed 130, deciding whether other output ports are used by the input port according to the old routing function R_{old}. In the simplest case the result of this test will ‘no’, i.e. only one output port is used by the input port according to the old routing function R_{old}, and the next step is to change to the new routing function R_{new} on the input port, as denoted by 180. Following this, the forwarding of data packets to the output port that have transmitted the token will start 190. The method will then end 200. The next time it is necessary to change to a new routing function, the method will start once again 110.

It is however more likely that the result of the test 130 is ‘yes’ e.g. several output ports are used by the input port according to the old routing function R_{old} . According to the method, the next untreated output port will be in focus 140, i.e. a port that has not already been assessed according to the next steps 150, 160 and 170. A test will then be performed 150 on this output port. If the output port can not expect any data packets from input ports that have not yet received the token, the specific output port will send the token 160, and the input ports destined to send data packets to the output port will start forwarding data packets 170 to the output port. After this step, it will once again be checked 130 whether more output ports are used by the input port according to R_{old}. After all the output ports used by the input port have been assessed, the next step will be 180,190 and finally 200.

If on the other hand, the result from the test in step 150 is ‘yes’, i.e. the current output port in focus can expect data packets according to the old routing function R_{old} from input ports that have not yet received the token, the output port will not send the token. In other word, the output port will only send the token when all input ports connected to it according to the old routing function R_{old} have sent the token to the output port. When this is the case the next steps 160 and 170 are performed, followed by step 130. When all the output ports used by the input port Iᵢ, according to the old routing function R_{old}, have been treated, the procedure will go through the next steps 180, 190 and 200. This may leave some output ports not having sent the token, even if they are used by the input port Iᵢ according to the old routing function R_{old}. These output ports still expect packets routed according to R_{old} from some input ports different from Iᵢ. These output ports will send the token at a later stage when some other input port receives the token, starting the actions of the flow chart again for this new input channel.

As mentioned the method according to the invention is executed on the input ports in a network element either sequential or synchronous. This means that the method presented by the flowchart in FIG. 6 will be executed accordingly with regard to each input port. For clarity reasons FIG. 6 only shows one implementation of the inventive steps to be performed according to the method for only one input port.

The result of the implementation of the method described above is firstly that data packets are sent either according to R_{old}, or R_{new}, i.e. no packets are routed according to R_{old}, in one network element and R_{new} in another. Secondly the method provides that for each link between input ports and output ports, data packets are sent solely according to R_{old} before the link starts sending data packets solely according to R_{new}.

The above method is the basis for deadlock freedom and in-order delivery of data packets.

Alternatives—Variations

The invention has been described by example and with reference to the detailed embodiment above. However, the skilled person in the art will realize that several variations and alternatives exist within the scope of the invention, as set forth in the appended claims. Some possible variations and alternatives will be described in the following.

For instance, it is not necessary to have an explicit token as a separate data packet. Information on which routing table the data packet should be routed according to can be included in the data packet itself. In that case there will be no token that marks the change from the old to the new routing function. Otherwise the method will be identical to the one described above.

Further the token can be piggybacked on the first packet that is to arrive after the token, or the last packet that was to arrive before the token.

Further, faulty components can be handled simply by assuming that the dead channels connected to the faulty components have already transmitted the token.

Further new components can be handled simply by assuming that the channels connected to the new components have already transmitted the token.

Although the method has been basically described as if it applied only to deterministic routing functions, in which every switch had only one choice of output port for any given packet, the method will also work on adaptive routing functions where each switch may have several output ports to choose from for each data packet. In that case in-order delivery will not be an issue anymore, because in adaptive routing functions per definition does not guarantee this. Deadlock freedom will, however, still be solved by the method. In the cases where the adaptive routing function gives rise to cyclic dependency graphs, this graph must be pruned into a non-cyclic one before the method applies. How this pruning should be done is however well known for a person skilled in the art.

An injection port is defined to be a port from which the network element can only expect data packets that have not been previously routed. A frequent example of such a port is where it is connected directly to a unit that generates network traffic. In cases where each network element, e.g. switch, knows which of its ports that are injection ports, the switch itself can decide when the packets arriving on the injection ports should start to be routed according to the new routing function. The alteration of the process described above is simply that at some point each switch decides to act as if it has received the token on all of its connected input ports. From that point on, the process is as described in the previous section. For most known routing functions the reception of tokens can be used to synchronize the start of the process in all switches.

In case the in-order delivery is not an important issue, the method according to the invention may be relaxed in such a way that an input port in a network element may send R_{new} packets to an output port that has not yet transmitted the token. This is allowed either if there are some packets that may be forwarded from this input port to the same output port both in R_{old} and R_{new}, or if the entire data packet can be transmitted onto the output port (thus cannot be stalled halfway between the ports), and packets with the same destination address may reside in this output port both according to R_{old} and R_{new}.

The method has been described in such a way that the token marks the change between the usage of R_{old} and R_{new} on a per link basis. This can also be done on a per packet source (TrafficNode) basis, simply by introducing one token per packet source. The changes required in the method itself are straightforward. In-order delivery is guaranteed, but extra measures need to be taken to avoid deadlock.

1. Method for deadlock free altering of a network routing from a first routing function R_{old}, defining an established connection between a plurality of communication input ports I₁, . . . ,Iₙ and output ports O₁, . . . ,Oₘ, in a network element, to a second routing function R_{new}, defining an new connection between the said input and output ports, for execution by the network element for transmitting and receiving data packets, said method comprising:
(1) for each input port Iᵢ, performing the following steps:
(1a) applying the first routing function R_{old} for the input port,
(1b) receiving a token on an input port Iᵢ,
(1c) applying the second routing function R_{new} for the input port Iᵢ,
(1d) forwarding data packets to every output port Oⱼ associated with the input port Iᵢ according to the second routing function R_{new}, provided that the output port Oⱼ has transmitted the token,
(2) for each output port Oⱼ, performing the following steps;
(2a) determining if the token has been received on all input ports associated with the output port Oⱼ according to the first routing function R_{old},
(2b) transmitting the token on the output port Oⱼ when the token has been received on all said input ports.

2. Method according to claim 1, wherein the network element is a switch.

3. Method according to claim 1 or 2, wherein the token is included in a data packet.

4. Method according to claim 1, wherein the method is applied to deterministic routing functions.

5. Method according to claim 1, wherein the method is applied to adaptive routing functions.

6. Method according to claim 1, wherein the method is applied to source routing.

7. Method according to claim 5, wherein if the adaptive method gives rise to a cyclic dependency graph, the graph is pruned into a non-cyclic one before the method is applied.

8. Method according to claim 1, wherein the method is applied to only parts of a complete network.

9. Network element, comprising
a plurality of output ports for transmitting data packets to other network elements in a network,
a plurality of input ports for receiving data packets from other network elements in the network,
a processing device,
a memory,
characterized in that the processing device is arranged to perform a method according to claim 1.

10. Network element according to claim 9, wherein said routing functions are implemented as tables stored in said memory.

11. Network element according to one of the claims 9 or 10, wherein said memory comprises computer program instructions arranged to perform said method when executed by said processing device.

12. Computer network system, comprising a number of network elements according to claim 9.

13. Computer program, embodied on a storage medium or in a memory, or carried by a propagated signal, for execution by a processing device in a network element, characterized in that the program comprises a set of instructions arranged to perform a method according to claim 1 when executed by the processing device in the network element.
